(19) United States
(12) Patent Application Publication
(10) Pub. No.: US 2011/0153877 A1
(43) Pub. Date: Jun. 23, 2011

(54) METHOD AND APPARATUS TO EXCHANGE DATA VIA AN INTERMEDIARY TRANSLATION AND QUEUE MANAGER

(76) Inventor: Steven R. King, Portland, OR (US)

(21) Appl. No.: 12/646,853

(22) Filed: Dec. 23, 2009

(51) Int. Cl. G06F 13/28

(52) U.S. Cl. 710/26

(57) ABSTRACT

Techniques for performing direct memory access (“DMA”) in an architecture wherein an interconnect separates I/O means from a DMA engine for handling DMA requests of the I/O means. In an embodiment, the I/O means sends via the interconnect a DMA request including an address-non-specific identifier of a queue which is a target of the DMA request. In another embodiment, the DMA engine determines an address-specific identifier of a location in the queue in response to the sending of the DMA request.

### BACKGROUND

1. Technical Field

Embodiments described herein relate generally to memory access and, more particularly, to a memory access using an intermediary direct memory access (“DMA”) engine.

2. Background Art

FIG. 1 illustrates elements of an apparatus 100 to perform a direct memory access (“DMA”) exchange according to a known technique. A memory system 130 of apparatus 100 includes a memory controller 150 and one or more memory devices 160. The memory controller 150 receives commands and data and transmits data over a primary bus 120. The memory controller 150 also receives commands and data from a DMA engine 140 of memory system 130 and transmits data to the DMA engine 140. The memory controller 150, in response to commands, reads or writes data to or from, respectively, the memory devices 160.

The DMA engine 140 in memory system 130 is remote from an input/output (I/O) adapter 110 of apparatus 100 in that it does not reside in the I/O adapter 110. The I/O adapter 110 must consequently communicate with the DMA engine 140 over the primary bus 120. The I/O adapter 110 programs the DMA engine 140, for example, by writing a DMA command block thereto. The command block for programming the DMA engine 140 includes a source address which specifies the location of the first piece of data in the memory system 130 and a length of data to transfer. The command block also includes a read buffer address specifying where the DMA engine 140 is to write the data transferred. The DMA engine 140, once programmed, accesses data in the memory system 130 in accordance with the programming. One access request is issued by the DMA engine 140 for each address specified by the source address and the stream length specified in the command block with which the DMA engine 140 is programmed.

In having the I/O adapter 110 specify to the DMA engine a source address, apparatus 100 requires that I/O adapter 110 maintain or otherwise have access to up-to-date source address information. This imposes a resource load to which I/O devices are increasingly sensitive, as increasingly large I/O throughput requirements are sought, and as systems make increasingly extensive use of virtualization techniques. For example, in a system employing virtualization techniques, the I/O adaptor 110 may be required to perform complex translation steps to derive a memory address suitable for DMA operations. As another example, an I/O adaptor 110 may be limited in performance due to the high access latency to Memory Devices 160 and DMA Engine 140.

### BRIEF DESCRIPTION OF THE DRAWINGS

The various embodiments discussed herein are illustrated by way of example, and not by way of limitation, in the figures of the accompanying drawings and in which:

FIG. 1 is a block diagram illustrating a system for performing direct memory access according to a previous technique.

FIG. 2 is a block diagram illustrating select elements of a system for performing direct memory access according to an embodiment.

FIG. 3 is a timing diagram illustrating select elements data exchange according to an embodiment.

FIG. 4 is a block diagram illustrating select elements of stream management information for accessing data according to an embodiment.

FIG. 5 is a block diagram illustrating select elements of a queue management information for accessing data according to an embodiment.

FIG. 6 is a block diagram illustrating select elements of a data packet format according to an embodiment.

FIG. 7 is a block diagram illustrating select elements of a method for accessing data according to an embodiment.

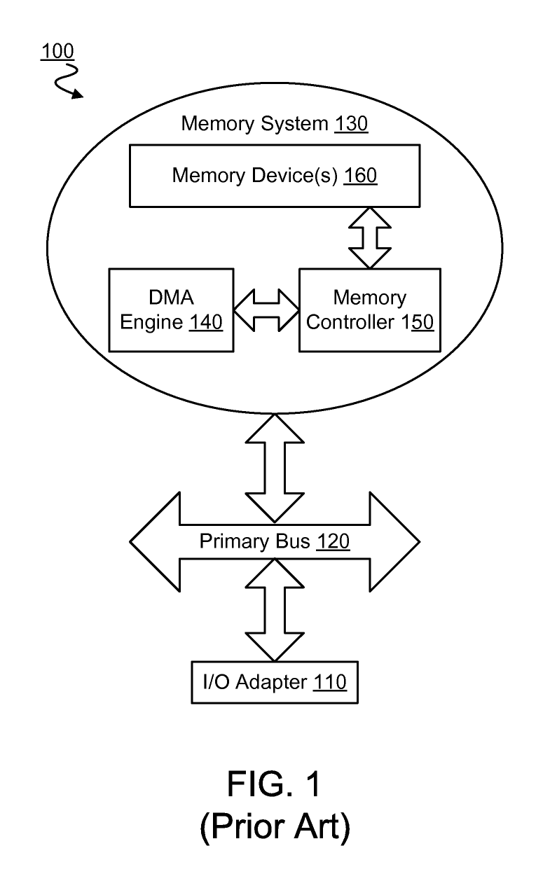

### DETAILED DESCRIPTION

DMA techniques are described herein for an architecture in which a DMA engine is disposed between an I/O means and a memory region to be accessed by a DMA request of the I/O means. As used herein, I/O means may refer to hardware and/or software means for exchanging data which is input to a system and/or data which is to be output from a system. An I/O means may also refer to a hardware and/or software means that performs computations on data already resident in a system and/or may return data back within the system. For example, an I/O means may include means for operating as a source and/or a sink of a data stream such as a network data stream. As another example, an I/O means may refer to an encryption engine that encrypts a data stream in which input and output remain resident in the system. The I/O means may be separated from the DMA engine by an interconnect, where a communication protocol of the interconnect supports an address-non-specific identification of a target for a memory access. By way of illustration and not limitation, the interconnect may be compatible with one or more of an open core protocol (OCP), a Peripheral Component Interconnect Express (PCIE) protocol, and the like. The interconnect may allow both traditional memory-address-specific operation and the memory-address-non-specific operation (proposed herein) to share interconnect resources. In an embodiment, the interconnect protocol may be a non-coherency protocol—e.g. a protocol which is not directed toward maintaining memory coherency for a particular coherency domain.

An I/O means may issue one or more DMA request messages which only indicate a target of a memory access with an address-non-specific identifier. For example, the I/O means may include a name of a memory region which is operated as a queue. The DMA request message, sent over the interconnect, may be received by a memory system, where the DMA engine provides mechanism for using the address-non-specific identifier to determine a current address-specific identifier for servicing the DMA request message. Determining the address-specific identifier may include identifying a current DMA transfer descriptor associated with a queue. For example, the DMA engine may identify a DMA transfer descriptor for a current point of writing data directly into, or reading data directly from, the queue. The I/O may have knowledge of certain properties of the queue, but does not need knowledge of the specific memory addresses underlying the control or data structures of the queue.

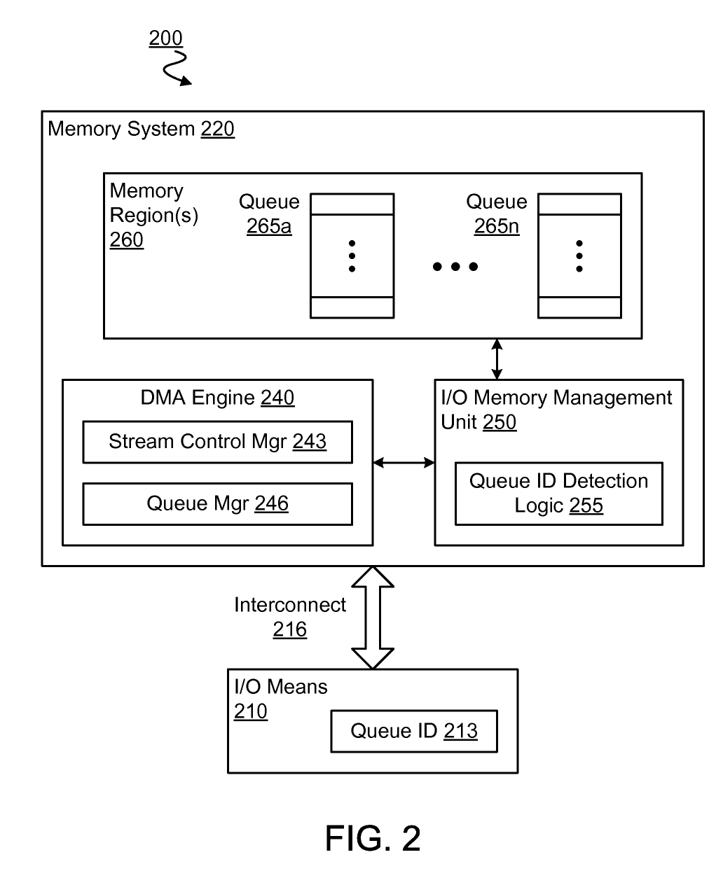

FIG. 2 illustrates select elements of a system 200 to exchange data by direct memory access (“DMA”) according to an embodiment. DMA is a memory access commonly known in the art wherein, in this context, a system such as system 200 may write directly to memory, and/or read directly from memory, without involving a general purpose processor. System 200 may reside, for example, on a platform for a desktop computer, laptop computer, notebook, cellular phone, digital audio and/or video player, or other similar computing device.

System 200 may include an I/O means 210 and a memory system 220 coupled thereto, e.g. via an interconnect 216. It is understood that I/O means 210 and memory system 220 may be coupled to one another by any of a variety of combinations of additional or alternative means, according to various embodiments. I/O means 210 may include a network interface or other any of a variety of logic to operate as a data source and/or a data sink for data. By way of illustration and not limitation, I/O means 210 may include a network interface card, I/O adapter or other similar device—or logic thereof—to operate as a source and/or sink for data of a data stream. I/O means 210 may operate to exchange a data stream with one or more other components of system 200 and/or a network coupled to system 200. For example, I/O means 210 may exchange a data stream with one or more peripheral devices (not shown) of system 200, such as a speaker and/or a display.

In an embodiment, I/O means 210 may reside on an integrated circuit (IC) which is separate from one or more components of memory system 220. However, a system-on-chip (SOC) implementation of system 200 may, according to an alternate embodiment, locate I/O means 210 and memory system 220 on the same IC. Memory system 220 may include one or more memory region(s) 260 to be accessed according to DMA techniques described herein. Memory region(s) 260 may include one or more regions—e.g. contiguous or not contiguous—of any of a variety of combinations of random access memory (“RAM”) types. Exemplary memory types include dynamic random access memories (“DRAM”) such as, but not limited to, synchronous DRAM (“SDRAM”), fast page mode RAM (“FPM RAM”), extended data out DRAM (“EDO DRAM”), burst EDO DRAM (“BEDO DRAM”), video RAM (“VRAM”), Rambus DRAM (“RDRAM”), synchronous graphic RAM (“SGRAM”), SyncLink DRAM (“SLDRAM”), and window RAM (“WRAM”). Memory region(s) 260 may also be organized in any suitable fashion. Memory region(s) 260 may be banked in a simply interleaved or a complexly interleaved memory organization. However, to a large degree, the organization of the memory region(s) 260 will be implementation specific.

Memory system 220 may include an I/O memory management unit (IOMMU) 250 to handle messages—e.g. from I/O means 210—to access memory regions(s) 260. More particularly, IOMMU 250 may communicate with a DMA engine 240 of memory system 220 to variously handle DMA requests of I/O means 210—e.g. requests to write to and/or read from memory region(s) 260. The DMA engine 240 in the particular embodiment of FIG. 2 resides in the memory system 220 although this is not necessary to certain embodiments.

For example, DMA engine 240 may operate to provide for DMA access by multiple memory systems 220, according to various embodiments. It is also understood that DMA engine 240 (or various components thereof) may reside within IOMMU 250, according to various embodiments. The DMA engine 240 is remote from the I/O means 210 in that it does not reside in the I/O means 210. The I/O means 210 must consequently communicate with the DMA engine 240 over at least one interconnect 216. DMA engines are well known and features of various DMA engines known to the art may be used to implement DMA engine 240. Some embodiments might, for instance, employ features of the DMA engine in the core of the Intel™ 8237 DMA controller or that in the core of the Intel™ 960 chipset.

To provide for DMA accesses to memory region(s) 260, DMA engine 240 may include a stream control manager 243 and/or a queue manager 246. Stream control manager 243 may include or otherwise access logic to generate, retrieve, update, communicate or otherwise determine information for implementing or handling DMA requests to exchange data of a data stream. For example, stream control manager 243 may create, maintain and/or provide information describing an association for use in sending—and/or responding to—data request messages for a data stream. Queue manager 246 may include or otherwise access logic to manage accesses to some or all of memory region(s) 260 as accesses to one or more queues—e.g. queues 265a, . . . , 265n. For example, queue manager 246 may generate, retrieve, update, communicate or otherwise determine information describing queues 265a, . . . , 265n. By way of illustration and not limitation, such information describing queues 265a, . . . , 265n may include information identifying a location of a queue, a range in memory of the queue, a DMA transfer descriptor (or pointer thereto) for a data read (and/or a data write).

A given queue of the one or more queues 265a, . . . , 265n may include multiple addresses, wherein address-specific identifiers specify different respective ones of the multiple addresses. Moreover, an address non-specific identifier may specify the given queue as a whole. By way of illustration and not limitation, an address non-specific identifier may include, for example, information specifying “the second queue”, “queue A”, “the queue with the most available memory”, “the least recently accessed queue”, and the like. The address non-specific identifier of a queue may include a name or descriptor which is sufficient to distinguish the queue from any other queue. Nevertheless, such an address-non-specific identifier of a queue may be generic to—e.g. not specifying—any particular address or addresses of that queue. Accordingly, in an embodiment, specifying a queue with the address non-specific identifier of the queue does not, in and of itself, specify any particular set of one or more addresses of the queue.

In an embodiment, I/O means 210 may store or otherwise have access to an address non-specific identifier of a queue—represented as queue ID 213. Queue ID 213 may, for example, be provided to I/O means 210 by stream controller 243. I/O means 210 may include queue ID 213 in one or more DMA requests to memory system 220. The interconnect 216 may implement a bus protocol in which queue ID 213 may be asserted thereon in writing to and/or reading from the memory region(s) 260. For example, queue ID 213 may be included in one or more DMA requests to indicate to memory system 220 that such requests are to exchange data for a particular data stream. IOMMU 250 may include queue ID detection logic 255 to detect from queue ID 213 in a DMA request that that DMA request is a request for a data stream. Inclusion/detection of queue ID 213 in a DMA request allows addressing to be achieved for DMA without I/O device 210 having to retrieve or otherwise keep track of a DMA transfer descriptor (or other addresses-specific identifier) for memory system 220.

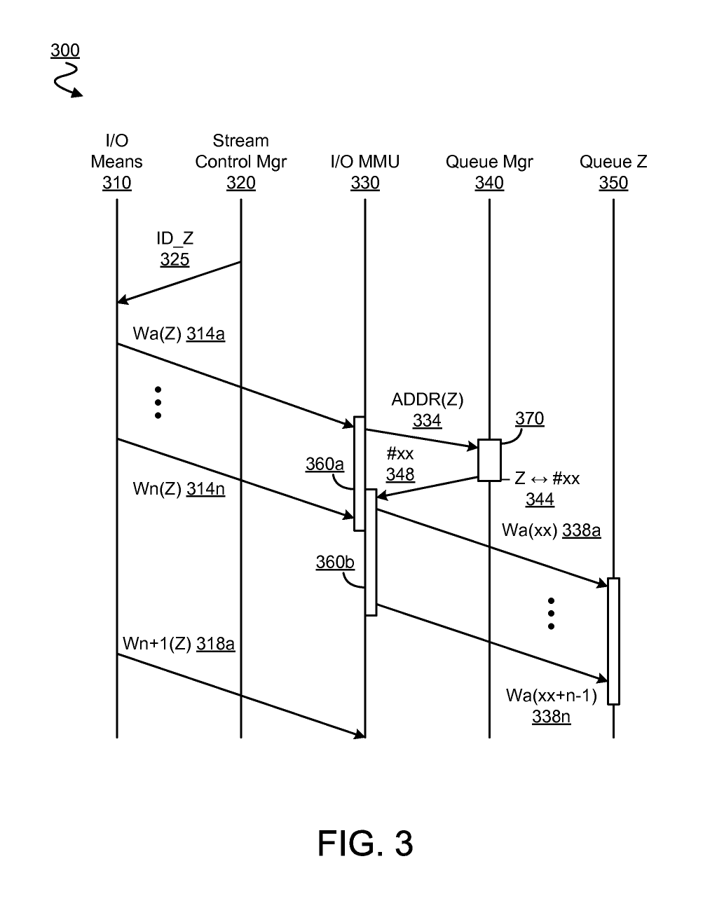

FIG. 3 illustrates select elements of a transaction 300 to perform DMA according to an embodiment. Transaction 300 may be performed by a system including features such as those described herein with respect to system 200, for example. In an embodiment, transaction 300 may include I/O means 310 receiving from stream control manager 320 a message ID_Z 325 indicating an address-non-specific identifier (e.g. “Z”) for a given queue—e.g. queue Z 350. I/O means 310 may then determine the address-non-specific identifier for queue Z 350 from message ID_Z 325. Thereafter, I/O means 310 may use the address-non-specific identifier for queue Z 350 to indicate that one or more DMA requests are to access data in queue Z.

By way of illustration and not limitation, some time after receiving message ID_Z 325, I/O means 310 may intend to perform a DMA of queue Z 350 to exchange data of a particular data stream. I/O means 310 may send to a memory system one or more DMA write messages Wa(Z) 314a, . . . , Wn(Z) 314n which include the address-non-specific identifier of queue Z 350. For the sake of brevity, certain features of various embodiments are described herein with respect to DMA write messages. It is understood that one or more DMA read requests, and/or any of a variety of other DMA writes requests, may be additionally or alternately sent by I/O means 310, according to various embodiments.

The one or more DMA write messages Wa(Z) 314a, . . . , Wn(Z) 314n may be received at an I/O MMU 330 of the memory system, e.g. wherein a received DMA write message does not include any address-specific identifier to specify any address of queue Z for a requested write. I/O MMU 330 may detect the address-non-specific identifier in messages Wa(Z) 314a, . . . , Wn(Z) 314n and, in response to the detecting, initiate operations to determine current values for one or more address variables associated with queue Z 350. For example, during a buffering phase 360a for I/O MMU 330 to buffer data of incoming messages Wa(Z) 314a, . . . , Wn(Z) 314n, I/O MMU 330 may send a message ADDR(Z) 334 to query a queue manager 340 for one or more DMA transfer descriptor values.

In response to ADDR(Z) 334, queue manager 340 may begin a process 370 to lookup or otherwise determine a DMA transfer descriptor which currently represents a location in queue Z to which DMA data is to be written. For example, process 370 may include queue manager 340 accessing a lookup table storing a “next write” DMA write descriptor—or a pointer thereto—which corresponds to queue Z 350. Queue manager 340 may be able, additionally or alternatively, to lookup or otherwise determine a DMA transfer descriptor which currently represents a location in queue Z from which DMA data is to be read.

Determining the one or more DMA transfer descriptor values may include, for example, identifying at 344 a currently relevant address-specific identifier (e.g. some virtual or physical address represented by “#xx”) which corresponds to the next location in queue Z 350 to receive data from a DMA write. It is understood that process 370 may include one or more address translation operations (e.g. virtual-to-virtual and/or virtual-to-physical) which result in the determining of the address-specific “#xx”.

Address-specific identifier “#xx” may then be provided to I/O MMU 330 in a message 348 for use in identifying one or more destinations for the DMA write messages of I/O means 310. It is understood that in certain embodiments, I/O MMU 330 may variously perform its own address translation operation(s) (e.g. virtual-to-virtual and/or virtual-to-physical, not shown) of identifier “#xx” to arrive at a final address-specific identifier for servicing the DMA requests Wa(Z) 314a, . . . , Wn(Z) 314n. In the illustrative case where no such address translation is performed by I/O MMU 330, address identifier “#xx” is the identifier which specifies a location in queue Z 350 for writing DMA data. For example, a process 360b to flush the data buffered by I/O MMU 330 may result in messages Wa(xx) 338a, . . . , Wn(x+n−1) 338n which write to queue Z 350 data from the corresponding one or more DMA write messages Wa(Z) 314a, . . . , Wn(Z) 314n.

The servicing of DMA write messages Wa(Z) 314a, . . . , Wn(Z) 314n may mean that the DMA transfer descriptor values determined for such servicing are not the current DMA transfer descriptor values to be used for some subsequent DMA access to queue Z 350. Nevertheless, in some subsequent DMA request message issued by I/O means 310—e.g. a DMA write request Wn+1(Z) 318a—I/O means 310 may still only indicate queue Z 350 (and/or addressable locations therein) with an address-non-specific identifier. For example, Wn+1(Z) 318a may only indicate queue Z with the same address-non-specific identifier for queue Z 350 which was included in DMA write messages Wa(Z) 314a, . . . , Wn(Z) 314n. The task of the resolving changes to the relevant DMA transfer descriptor values to be used in servicing Wn+1(Z) 318a is left to an intermediary DMA engine or other similar mechanisms disposed between I/O means 310 and queue Z 350.

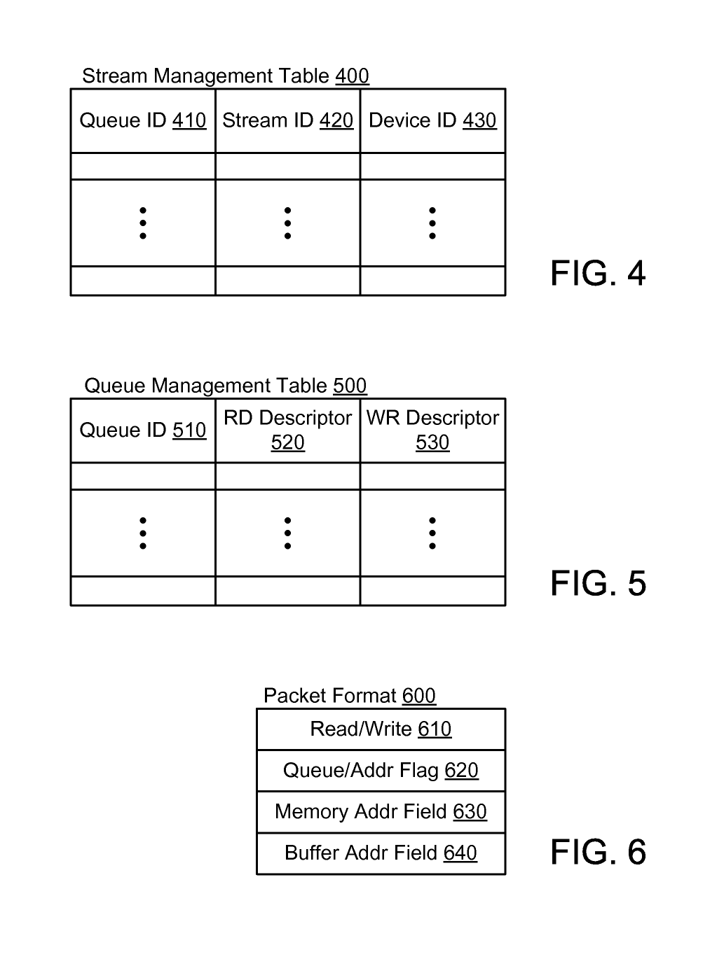

FIG. 4 illustrates select elements of a stream management table 400 for implementing and/or handling DMA requests according to an embodiment. Stream management table 400 represents information which may be generated, retrieved, maintained, provided or otherwise determined by an intermediary DMA engine separated from an I/O means by one or more interconnects. For example, stream management table 400 may be stored by, or accessible to, stream control manager 243 of DMA engine 240.

In an embodiment, stream management table 400 may be used for implementing and/or handling DMA requests to exchange data of a data stream, wherein the data is variously written to and/or read from a memory region which is operated as a queue. Stream management table 400 may store information directly or indirectly associating a given queue with a given data stream. By way of illustration and not limitation, stream management table 400 may include one or more entries, each including a respective queue identifier value, queue ID 410. Queue ID 410 may include information determining an address-non-specific identifier of a given queue, such as described herein.

Each entry of stream management table 400 may further include another identifier indicating an association of a particular data stream with the queue ID 410 for that entry. For example, an entry of stream management table 400 may include a value stream ID 420 identifying a data stream which is assigned to write data to, and/or read data from, the particular queue indicated by that entry. Alternatively or in addition, an entry stream management table 400 may include a device ID 430 identifying a particular device—e.g. a device of I/O means 210—implementing a data stream which is thereby indirectly associated with the particular queue indicated by that entry. It is understood that stream management table 400 may include any of a variety of additional or alternative combinations of information for implementing and/or handling DMA requests for a data stream, according to various embodiments. For example, an embodiment may employ security fields in table 400 to constrain behavior or control access by I/O means 210.

Stream management table 400 may be used to indicate to an I/O means that a particular queue is associated with a data stream which is exchanged via the I/O means. Communicating the association may include indicating to the I/O means an address-non-specific identifier for the associated queue. The I/O means may then include the queue's address-non-specific identifier in one or more DMA request messages. The I/O means may further include in such a DMA request message an indication that the address-non-specific identifier is not some other expected form of addressing a location in the associated queue.

FIG. 5 illustrates select elements of a queue management table 500 for implementing and/or handling DMA requests according to an embodiment. Queue management table 500 represents information which may be generated, retrieved, maintained, provided or otherwise determined by an intermediary DMA engine separated from an I/O means by one or more interconnects. For example, queue management table 500 may be stored by, or accessible to, queue manager 246 of DMA engine 240.

In an embodiment, queue management table 500 may be used for determining from an address-non-specific identifier of a queue a current value for an address variable—e.g. a DMA transfer descriptor variable. For example, queue management table 500 may store information directly or indirectly associating a given queue with a DMA transfer descriptor (or pointer thereto), where the association changes successive writes to and/or reads from the queue.

By way of illustration and not limitation, queue management table 500 may include one or more entries, each including a respective queue name value, queue ID 510. Queue ID 510 may include information determining an address-non-specific identifier of a given queue, such as described herein. An entry in queue management table 500 may further include a field to indicate a DMA transfer descriptor currently associated with the queue which is also indicated by that entry. For example, queue management table 500 may store RD descriptor 520—e.g a DMA transfer descriptor (or pointer thereto) for a location of a queue from which data is next to be read by a particular type of DMA read operation. Additionally or alternatively, queue management table 500 may store WR descriptor 530—e.g a DMA transfer descriptor (or pointer thereto) for a location of the queue to which data is next to be written by a particular type of DMA write operation. It is understood that queue management table 500 may include any of a variety of additional or alternative combinations of information for determining from an address-non-specific identifier of a queue a current value for an address variable—e.g. a DMA transfer descriptor variable—according to various embodiments.

FIG. 6 illustrates select elements of a data packet format 600 according to an embodiment. A data packet according to packet format 600 may be sent from an I/O means over an interconnect separating the I/O means from a DMA engine for servicing DMA requests of the I/O means. For example, a data packet according to packet format 600 may be sent by I/O means 210 over interconnect 216.

Communication on such an interconnect may be according to a protocol which supports use of an address-non-specific identifier to indicate a target of a memory access request. For example, such a protocol may specify that a particular data packet field of a data packet format is, under some condition, to represent an address-specific identifier of an addressable location in memory. However, the protocol may include some extension for that particular data packet field wherein, under some alternate condition, the data packet field is instead to represent an address-non-specific identifier. For example, the data packet format may include some additional indicator to a recipient of the data packet that, instead of containing a particular address (physical or virtual), a target address field instead contains only an address-non-specific identifier—e.g. a name—of a queue having multiple addressable locations, each identified with a different respective address-specific identifier.

By way of illustration and not limitation, packet format 600 may include a read/write field 610 to indicate whether a data packet is for a DMA read request or a DMA write request. Additionally or alternatively, packet format 600 may include a queue/address flag 620 to indicate whether a field of the data packet—used to indicate a target of the DMA request—contains an address-specific identifier or an address-non-specific identifier. In an embodiment, the address-non-specific identifier may include an identifier of a queue in a target memory region. Additionally or alternatively, packet format 600 may include a memory address field 630 to contain information identifying a target of a memory request. Based on the value of queue/address flag 620, memory address field 630 may be repurposed to store an address-non-specific identifier, as described above.

Additionally or alternatively, packet format 600 may include a buffer address field 640 to indicate a location where data is to written to (or read from) for DMA reading from (or DMA writing to) the memory region associated with the information contained in memory address field 630. In an embodiment, buffer address field 640 may indicate a location of a buffer in the I/O means, where a DMA access of a queue in a memory region is to read data which is to be written to the location indicated by buffer address field 640. Additionally or alternatively, a DMA access of a queue in a memory region may be to write data which has been read from the location indicated by buffer address field 640. It is understood that packet format 600 may include any of a variety of additional or alternative combinations of information for implementing a DMA request, according to various embodiments.

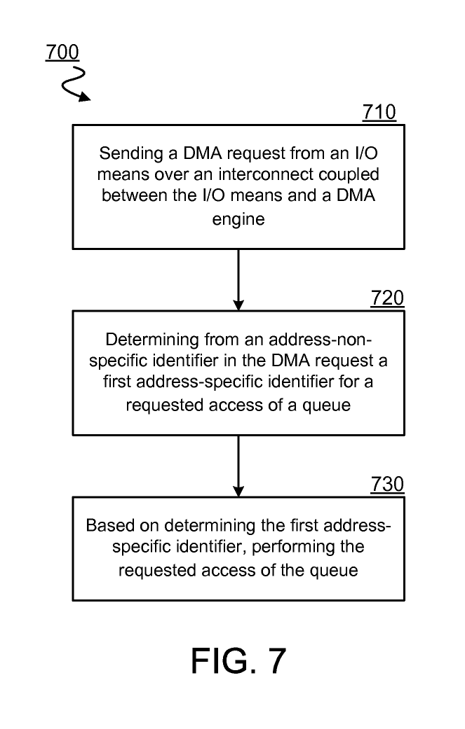

FIG. 7 illustrates select elements of a method 700 for performing a direct memory access according to an embodiment. In an embodiment, method 700 may be performed by a system having some or all of the features described with respect to system 200, for example.

Method 700 may include, at 710, sending a DMA request from an I/O means over an interconnect coupled between the I/O means and a DMA engine. The DMA request may include a message requesting an access of a region of a memory operated as a queue having multiple addresses. The multiple addresses of the queue may each be specified by a different respective address-specific identifier. Moreover, the queue itself may be specified by an address-non-specific identifier which, for example, may be included in the DMA request. The address-non-specific identifier may be included in the DMA request in response to information which the I/O means receives from a memory system which includes the DMA engine. For example, a memory system which handles DMA requests to access the queue—e.g. a memory system including the DMA engine—may provide to I/O means information associating the address-non-specific identifier with a particular data stream which is implemented using the I/O means.

The I/O means may, in an embodiment, include a value in a first field of the DMA request to indicate to the memory system that a second field of the DMA request contains address-non-specific information for identifying a target of the DMA request. For example, a value of the first field may indicate whether the second field includes address-specific identifier information or address-non-specific identifier information. In response to the sending of the DMA request, the DMA engine may, at 720, determine from the address-non-specific identifier in the DMA request a first address-specific identifier for the access of the queue.

Determining the address-specific identifier may include, for example, providing the address-non-specific identifier to identify a DMA transfer descriptor currently associated with the queue. Determining the address-specific identifier may further include, for example, identifying a type of access requested by the DMA request. In an embodiment, identifying the DMA transfer descriptor currently associated with the queue may include identifying a DMA transfer descriptor currently associated with the queue for the identified type of access.

Based on the determining of the first address-specific identifier, the method may, at 730, perform the requested access of the queue. The requested access may include performing at least one of a DMA write to the queue and a DMA read from the queue. Performing the requested access may include exchanging data between a buffer of the I/O means and a location in the queue identified by the address-specific identifier.

Techniques and architectures for accessing a memory are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions which follow are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of certain embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A method comprising:
sending a DMA request from an I/O interface over an interconnect coupled between the I/O interface and a DMA engine, the DMA request for an access of a queue having multiple addresses each specified by a different respective address-specific identifier, the DMA request including an address-non-specific identifier specifying the queue; and
in response to the sending the DMA request:
the DMA engine determining from the address-non-specific identifier in the DMA request a first address-specific identifier for the access of the queue; and
based on the determining the first address-specific identifier, performing the access of the queue.

2. The method of claim 1, wherein determining the first address-specific identifier includes providing the address-non-specific identifier to identify a DMA transfer descriptor currently associated with the queue.

3. The method of claim 1, wherein a memory system including the DMA engine handles DMA requests to access the queue, the method further comprising:
prior to sending the DMA request from the I/O interface, the I/O interface receiving the address-non-specific identifier from the memory system.

4. The method of claim 3, wherein the DMA request is to exchange data of a first data stream, and wherein the I/O interface receiving the address-non-specific identifier from the memory system includes the I/O interface receiving information associating the address-non-specific identifier with the first data stream.

5. The method of claim 4, the method further comprising:
prior to sending the DMA request from the I/O interface, including the address-non-specific identifier in the DMA request in response to the information associating the address-non-specific identifier with the first data stream.

6. The method of claim 1, further comprising:
identifying from a value in a first field of the DMA request that a second field of the DMA request contains address-non-specific information for identifying a target of the DMA request.

7. The method of claim 1, wherein determining from the address-non-specific identifier in the DMA request the first address-specific identifier includes:
identifying a type of access requested by the DMA request; and
identifying a DMA transfer descriptor currently associated with the queue for the identified type of access.

8. An apparatus comprising:
a DMA engine;
an interconnect; and
an I/O interface separated from the DMA engine at least by the interconnect, the I/O interface to exchange data for the apparatus, including the I/O interface to send over the interconnect a message requesting direct memory access (DMA) to a memory region operated as a first queue having multiple addresses each specified by a different respective address-specific identifier, the message including an address-non-specific identifier specifying the queue,
wherein in response to the sending the message, the DMA engine to determine from the address-non-specific identifier in the message a first address-specific identifier for the access of the queue, and
wherein the DMA of the first queue is performed based on the determining the first address-specific identifier.

9. The apparatus of claim 8, wherein the DMA engine to determine the first address-specific identifier
the DMA engine to determine, based on the address-non-specific identifier, a DMA transfer descriptor currently associated with the first queue.

10. The apparatus of claim 8, the DMA engine further to provide the address-non-specific identifier of the first queue to the I/O interface, and wherein the I/O interface to include the address-non-specific identifier of the first queue in the message based on the providing.

11. The apparatus of claim 10, wherein the DMA engine to provide the address-non-specific identifier of the first queue to the I/O interface, includes the DMA engine to provide to the I/O interface information associating the first queue with a first data stream.

12. The apparatus of claim 8, wherein the I/O interface to send the message comprises the I/O interface to include in the message a first value in a first field of the message specifying that a second field of the DMA request contains address-non-specific information for identifying a target of DMA.

13. A system comprising:
a memory device;
a DMA engine coupled to the memory device;
an interconnect; and
an I/O interface separated from the DMA engine at least by the interconnect, the I/O interface to exchange data for the apparatus, including the I/O interface to send over the interconnect a message requesting direct memory access (DMA) to a memory region operated as a first queue having multiple addresses each specified by a different respective address-specific identifier, the message including an address-non-specific identifier specifying the queue,
wherein in response to the sending the message, the DMA engine to determine from the address-non-specific identifier in the message a first address-specific identifier for the access of the queue, and
wherein the DMA of the first queue is performed based on the determining the first address-specific identifier.

14. The system of claim 13, wherein the DMA engine to determine the first address-specific identifier
the DMA engine to determine, based on the address-non-specific identifier, a DMA transfer descriptor currently associated with the first queue.

15. The system of claim 13, the DMA engine further to provide the address-non-specific identifier of the first queue to the I/O interface, and wherein the I/O interface to include the address-non-specific identifier of the first queue in the message based on the providing.

16. The system of claim 15, wherein the DMA engine to provide the address-non-specific identifier of the first queue to the I/O interface, includes the DMA engine to provide to the I/O interface information associating the first queue with a first data stream.

17. The system of claim 13, wherein the I/O interface to send the message comprises the I/O interface to include in the message a first value in a first field of the message specifying that a second field of the DMA request contains address-non-specific information for identifying a target of DMA.
